(19) United States
(12) Patent Application Publication
(10) Pub. No.: US 2016/0203446 A1
(43) Pub. Date: Jul. 14, 2016

(54) MOBILE TEXTILE RECYCLING REDEMPTION SYSTEM AND METHOD OF USE

(71) Applicant: JOHN LEE, Las Vegas, NV (US)

(72) Inventor: JOHN LEE, Las Vegas, NV (US)

(21) Appl. No.: 14/593,120

(22) Filed: Jan. 9, 2015

(51) Int. Cl. G06Q 10/00

(52) U.S. Cl. CPC G06Q 10/30

(57) ABSTRACT

A mobile textile recycling redemption system includes a mobile storage unit; one or more conveyor members for directing recyclables into the mobile storage unit; a scale for weighing the recyclables; means for monetizing a value of the weighed recyclables; a terminal configured to receive instructions from a donor of the recyclables, the instructions related to the donation of the monetized value to one or more designees, host business or retention by the donor of recyclables.

### FIELD OF THE INVENTION

The embodiments of the present invention relate to a mobile center for recycling textiles and miscellaneous goods and means for directing funds associated therewith.

### BACKGROUND

The donation and recycling of goods, such as textiles, is a burgeoning business. Indeed, many business models exist for accepting donations and administering the same including: (i) donations via donation bins (e.g., Safe Nest, Peoples, Big Brothers/Big Sisters, etc.); (ii) donations via attended donation stations (e.g., Goodwill); (iii) donations at thrift store locations (e.g., Opportunity Village and Salvation Army); (iv) donations via home pickups; and (v) donations via charity drives.

Unfortunately, the current donation models suffer from drawbacks. For example, donation bins invariably end up attracting unsightly messes including poor quality donations and even trash. Such premises may further attract indigents and homeless. Under such circumstances, the property owner demands that the donation bin be removed. In another example, attended donation centers may be utilized. The inherent problems with the attended donation center are its large footprint and single dedicated charity.

It would be useful to develop a textile recycling redemption model which overcomes the shortcomings of the donation models currently being used.

### SUMMARY

Accordingly, one embodiment of the mobile textile recycling redemption system comprises a mobile recycling redemption system includes a mobile storage unit; one or more conveyor members for directing recyclables into the mobile storage unit; a scale for weighing the recyclables; means for monetizing a value of the weighed recyclables; a terminal configured to receive instructions from a donor of the recyclables, the instructions related to the donation of said monetized value to one or more charities, host business or retention by the donor of recyclables.

In one embodiment, the terminal permits a donor of recyclables to directly donate the monetized value thereof to one or more designees (e.g., charities, vendors, etc.) or keep the monetized value. The contribution or payment of the monetized value may be transmitted directly to the one or more designees through a network involving the terminal or via a central financial account or administrative financial account from which the monetized value is distributed to one or more charities. In one embodiment, the monetized value is provided to the donor of the recyclables in the form of a coupon or voucher limited to use at the business (e.g., grocery store) hosting the mobile textile recycling redemption system.

Other variations, embodiments and features of the present invention will become evident from the following detailed description, drawings and claims.

### BRIEF DESCRIPTION OF THE DRAWINGS

FIG. 1 illustrates hardware associated with a mobile textile recycling redemption center according to the embodiments of the present invention;

FIG. 2 illustrates a first network associated with the mobile textile recycling redemption center according to the embodiments of the present invention;

FIG. 3 illustrates a second network associated with the mobile textile recycling redemption center according to the embodiments of the present invention;

FIG. 4 illustrates a flow chart detailing one methodology for using the mobile textile recycling redemption center according to the embodiments of the present invention; and

FIG. 5 illustrates an exemplary screen shot of a charity selection input for the donor according to the embodiments of the present invention.

### DETAILED DESCRIPTION

For the purposes of promoting an understanding of the principles in accordance with the embodiments of the present invention, reference will now be made to the embodiments illustrated in the drawings and specific language will be used to describe the same. It will nevertheless be understood that no limitation of the scope of the invention is thereby intended. Any alterations and further modifications of the inventive feature illustrated herein, and any additional applications of the principles of the invention as illustrated herein, which would normally occur to those skilled in the relevant art and having possession of this disclosure, are to be considered within the scope of the invention claimed.

Those skilled in the art will recognize that the embodiments of the present invention involve both hardware and software elements which portions are described below in such detail required to construct and operate a mobile textile recycling redemption center according to the embodiments of the present invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.), or an embodiment combining software and hardware. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), and optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied thereon, for example, in baseband or as part of a carrier wave. Such a propagated signal may take any variety of forms, including, but not limited to, electromagnetic, optical, or any suitable combination thereof. A computer readable signal medium may be any computer readable medium that is not a computer readable storage medium and that can communicate, propagate, or transport a program for use by or in conjunction with an instruction execution system, apparatus, or device.

Program code embodied on a computer readable medium may be transmitted using any appropriate medium, including but not limited to wireless, wireline, optical fiber cable, RF and the like, or any suitable combination of the foregoing.

Computer program code for carrying out operations for aspects of the present invention may be written in any combination of one or more programming languages, including an object oriented programming language such as Java, Smalltalk, C++ or the like or conventional procedural programming languages, such as the “C” programming language, AJAX, PHP, HTML, XHTML, Ruby, CSS or similar programming languages. The programming code may be configured in an application, an operating system, as part of a system firmware, or any suitable combination thereof The programming code may execute entirely on the user's computer, partly on the user's computer, as a stand-alone software package, partly on the user's computer and partly on a remote computer or entirely on a remote computer or server as in a client/server relationship sometimes known as cloud computing. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks. As used herein, a “terminal” should be understood to be any one of a general purpose computer, as for example a personal computer or a laptop computer, a client computer configured for interaction with a server, a special purpose computer such as a server, or a smart phone, soft phone, tablet computer, personal digital assistant or any other machine adapted for executing programmable instructions in accordance with the description thereof set forth above.

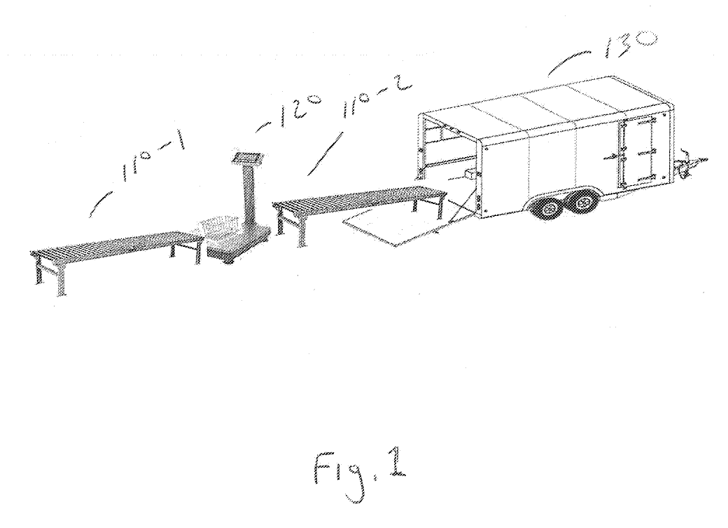

FIG. 1 illustrates hardware associated with a mobile recycling redemption center 100 according to the embodiments of the present invention. In broad terms, the mobile textile recycling redemption center 100 includes one or more manual or automatic conveyor members 110-1, 110-2, a scale 120 and a mobile storage unit 130. In operation, textile recyclables, such as clothing, apparel, blankets, towels, shoes, hats, scarves, etc., are hand-processed by staff by sorting, weighing and placing the same in said mobile storage unit 130. Advantageously, when full, the mobile storage unit 130 can be removed and replaced with a new empty mobile storage unit. The mobile recyclable redemption center 100 may be set up anywhere but proximate to a large anchor type of host business is ideal to attract large numbers of donors and provide convenience.

The value of said recyclables is determined by the operator managing the mobile recycling redemption center 100. Conventional rates for textiles recyclables vary between 3¢ and 30¢ per pound. Those skilled in the art will recognize that other recyclable rates are conceivable.

Once a value for the donated textiles is determined, the mobile recycling redemption center 100 is configured to electronically facilitate payment of the recyclable donation value to the donor and/or third parties pursuant to the donor's instructions. In one embodiment, options for the donor include: (i) donating the textile recyclables to the mobile recycling redemption center to prevent additional textiles from finding their way into landfills; (ii) donating the monetized value of the textiles to a charity of their choice or other designee; (iii) receive the monetized value of the textiles in the form of a coupon or voucher which can be redeemed at a host business (e.g., grocery store, big box outlet, etc.) at or near the premises for cash or credit; and (iv) receive monetized value of textiles which can be loaded onto a magnetic or smart card for donor use.

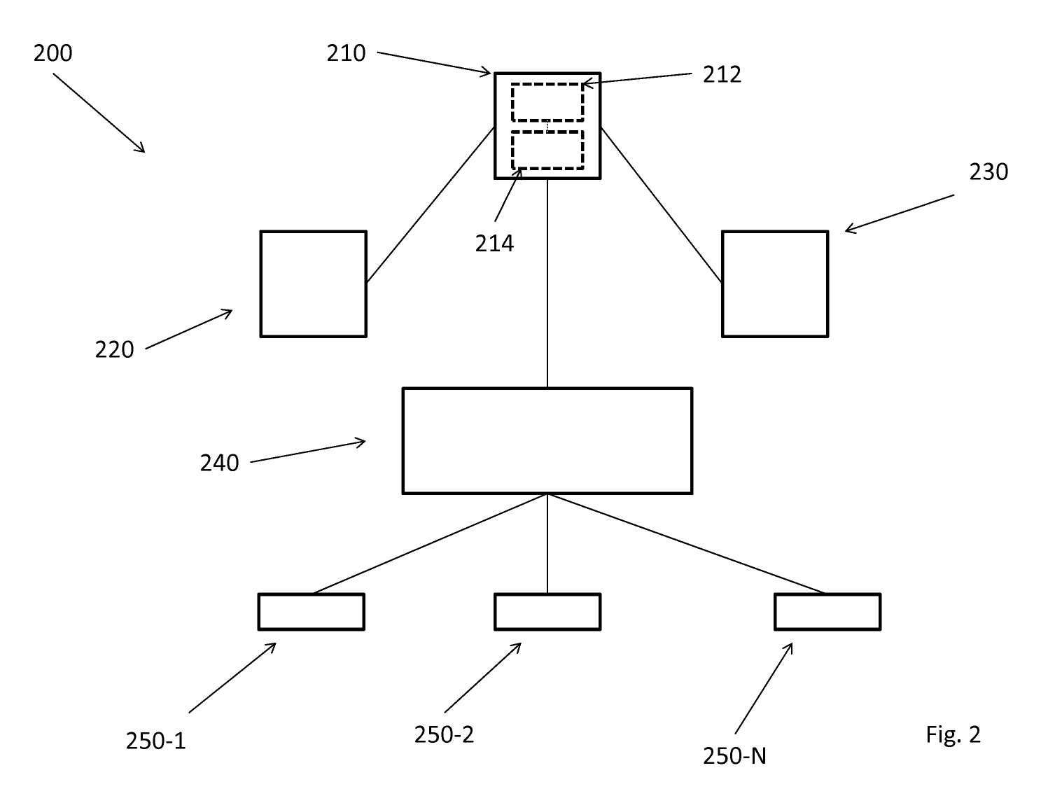

FIG. 2 shows a first network 200 of the type associated with the embodiments of the present invention. A terminal 210 includes a processor/controller, display, memory and user interface and is communicatively linked to a printer 220 and a card loader 230 configured to add value to a magnetic card or smart card. The terminal 210 is of a conventional type through which the operator and donor may interact as needed. The terminal 210 may be a mobile device such as a properly configured smart phone or tablet. The terminal 210 may be communicatively linked to the scale 120 such that weight totals are automatically transmitted to the terminal 210. The terminal 210 is further communicatively linked to a central financial repository or financial account 240 which is then communicatively linked to individual financial accounts for numerous charities 250-1 through 250-N for purposes disclosed below. In one embodiment, the central repository or financial account may be that of the operator of the mobile recycling redemption center 100. The terminal 210 may run software 212 to facilitate the monetization of the donated textiles or be in communication with a server running the same. The software 212 may include an accounting module 214.

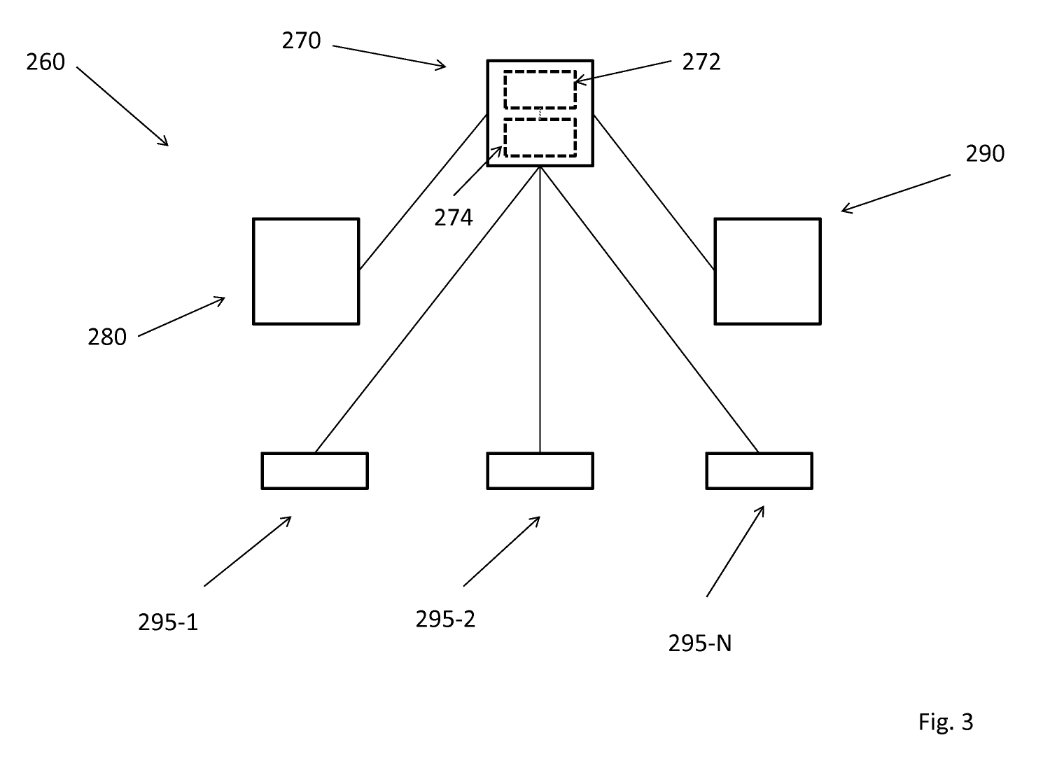

FIG. 3 shows a second network 260 of the type associated with the embodiments of the present invention. A terminal 270 includes a processor/controller, display, memory and user interface and is communicatively linked to a printer 280 and a card loader 290 configured to add value to a magnetic card or smart card. The terminal 270 is of a conventional type through which the operator and donor may interact as needed. The terminal 270 may be a mobile device such as a properly configured smart phone or tablet. The terminal 210 may be communicatively linked to the scale 120 such that weight totals are automatically transmitted to the terminal 210. The terminal 270 is further communicatively linked directly to individual financial accounts for numerous charities 295-1 through 295-N for purposes disclosed below. The terminal 270 may run software 272 to facilitate the monetization of the donated textiles or be in communication with a server running the same. The software 272 may include an accounting module 274. Regarding either network 200, 260, the communicative links may be facilitated by wired or wireless connections between the various hardware components.

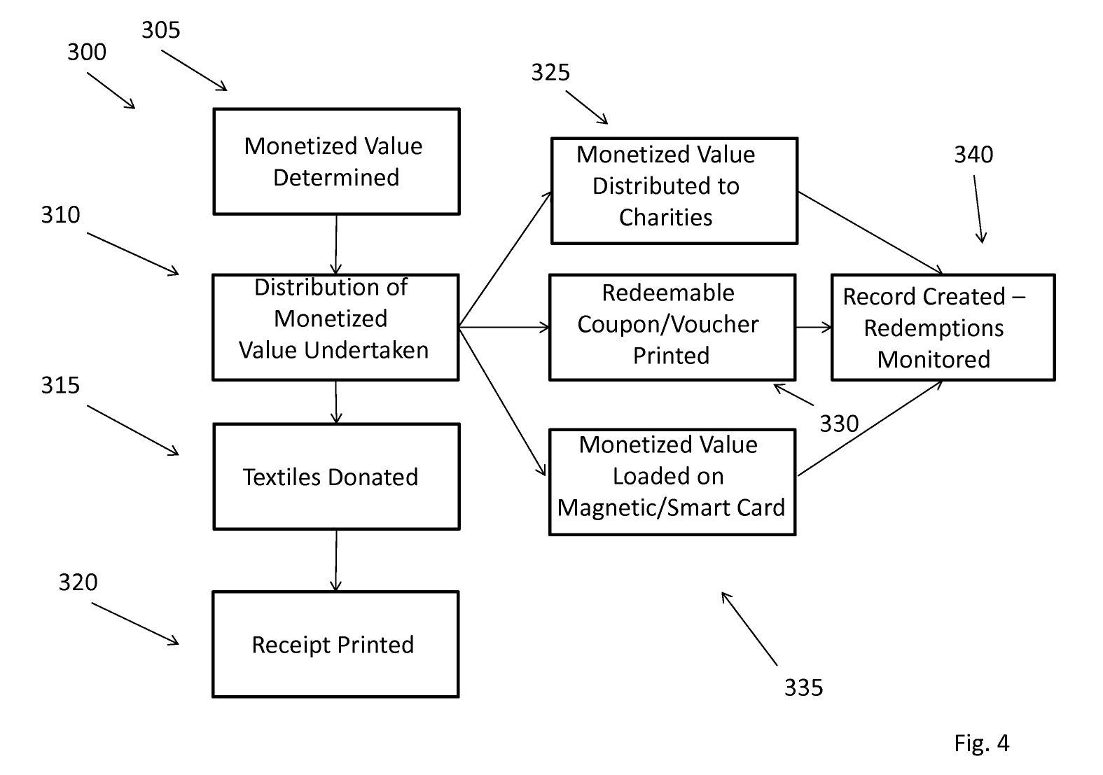

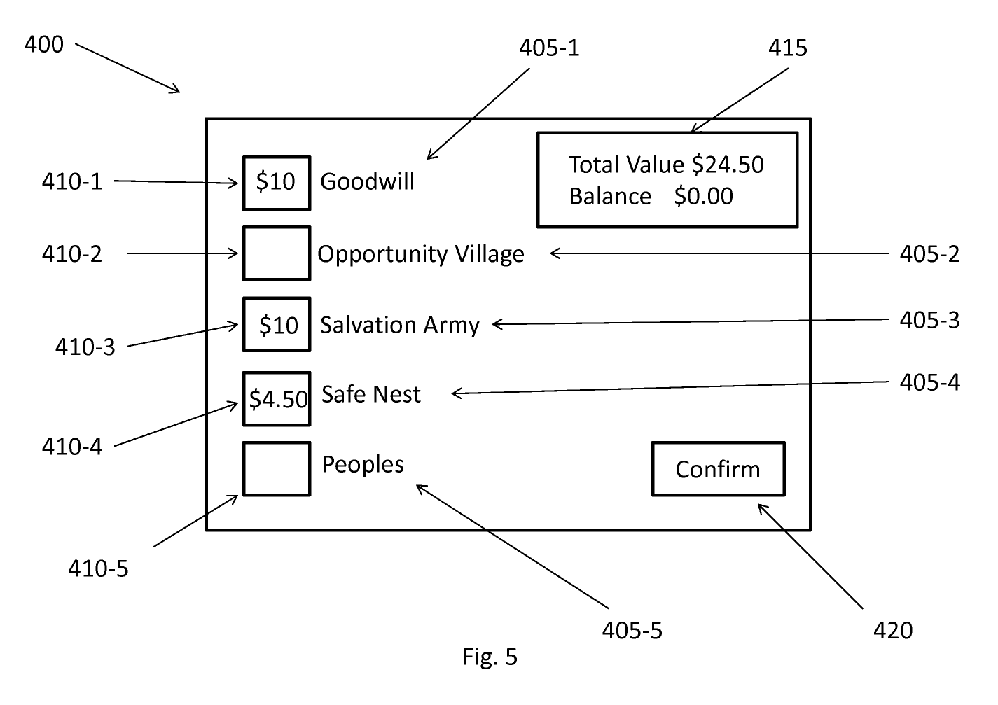

FIG. 4 shows a flow chart 300 detailing a methodology of use associated with the mobile recycling redemption center 100 related to charities. Of course, other designees may benefit as well. At 305, a monetized value of the donated textiles is determined. At 310, via the terminal 210, a staff member associated with mobile recycling redemption center 100 handles the distribution of the monetized value of the textiles. If, at 315, the donor elects to donate the textiles without receiving the monetized value, at 320, a charitable deduction receipt is printed for tax purposes. At 325, the donor may elect to donate the monetized value of the textiles to a charity of his or her choice. Through the terminal 210 a staff member associated with the mobile recycling redemption center 100 may present the donor with charity options on a display thereof (see FIG. 5). The donor may selected one or more charities to distribute the monetized value of the textiles. The amounts donated to each charity may be equal or different as determined by the donor. As set forth above, the distribution of the monetized value may be accomplished through a central financial repository or financial account 240 which handles distribution to the various charities with which it is connected. Alternatively, the terminal 210 may be in direct contact with accounts associated with the charities. In another embodiment, the operator of the mobile recycling redemption center 100 may collect the donations for the various charities and distribute the monies accordingly. At 330, the donor may receive the monetized value of the textiles in the form of a coupon or voucher which can be redeemed at a host business at or near the premises for cash or credit. The printer 220 is instructed by the terminal 210 to print the appropriate coupon or voucher for later redemption. In one embodiment, the coupon or voucher is limited to redemption as a store credit at the host business. In another embodiment, the coupon or voucher may be redeemed for cash at the host business. At 335, the donor may receive the monetized value of textiles on a loaded magnetic or smart card for donor use. Under this option, the operator utilizes the card loader 230 to load value onto a magnetic card, smart card or the like which permits the user to redeem the monetized value at a later time. In one embodiment, the magnetic card or smart card may be associated with the host business such that the donor may only use the card at the host business. Alternatively, the magnetic or smart card may be associated with a non-host business selected by the donor or operator of the mobile recycling redemption center 100. At 340, the accounting modules 272, 274 associated with the networks 200 and 250, respectively, monitor and maintain records of redemptions and charitable contributions processed through the mobile recycling redemption center 100.

FIG. 5 shows an exemplary screen shot 400 of a charity selection input for the donor according to the embodiments of the present invention. The screen shot 400 depicts a series of charities 405-1 through 405-N, donation boxes 410-1 through 410-N proximate thereto and a total monetized value window 415. As a donor enters individual donations amounts into the donation boxes 410-1 through 410-N, a monetized balance total is reduced. As shown, the monetized balance total is $0 as three donations totaling $24.50 have been entered thereby using the total monetized value available. A confirm link 420 is used to finalize the donation transaction.

While recyclable textiles are the focus of this detailed description, it is apparent that the mobile textile recycling redemption center 100 may be used for other recyclables including furniture, small appliances and other miscellaneous goods, etc.

Although the invention has been described in detail with reference to several embodiments, additional variations and modifications exist within the scope and spirit of the invention as described and defined in the following claims.

I claim:

1. A mobile textile recycling redemption system comprising:
one or more conveyor members;
a scale;
a mobile storage unit;
a terminal comprising at least a processor, display, user interface and memory;
said terminal configured to accept at least weighed amounts of recyclables and determine a monetized value thereof, said terminal communicatively linked to financial accounts of one or more designees; and
wherein said user interface of said terminal is further configured to permit a donor of recyclables to transmit all or portions of said monetized value of said recyclables to one or more designees associated with said mobile recycling redemption system.

2. The mobile textile recycling redemption system of claim 1 wherein said scale is communicatively linked to said terminal.

3. The mobile textile recycling redemption system of claim 1 wherein said user interface of said terminal is further configured to permit a donor of recyclables to select an unequal distribution of a monetized value of said recyclables to two or more designees associated with said mobile recycling redemption system.

4. The mobile textile recycling redemption system of claim 1 wherein said terminal is communicatively linked to financial accounts of said one or more designees.

5. The mobile textile recycling redemption system of claim 1 wherein said terminal is communicatively linked to an administrative financial account which is communicatively linked to financial accounts of said one or more designees.

6. The mobile textile recycling redemption system of claim 1 further comprising an accounting module for recording and maintaining monetized value and redemptions thereof.

7. The mobile textile recycling redemption system of claim 1 further comprising a printer communicatively linked to said terminal.

8. A mobile textile recycling redemption system comprising:
one or more conveyor members;
a scale;
a mobile storage unit;
magnetic or smart card loader;
a terminal comprising at least a processor, display, user interface and memory, said terminal communicatively linked to said magnetic or smart card loader;
said terminal configured to accept at least weighed amounts of recyclables and determine a monetized value thereof; and
wherein said terminal is further configured to instruct said magnetic or smart card loader to load said magnetic or smart card with said monetized value of said recyclables.

9. The mobile textile recycling redemption system of claim 8 wherein said scale is communicatively linked to said terminal.

10. The mobile textile recycling redemption system of claim 8 wherein said loaded magnetic card or smart card is limited to use at a host business.

11. The mobile textile recycling redemption system of claim 8 wherein said loaded magnetic card or smart card is limited to use at a non-host business.

12. The mobile textile recycling redemption system of claim 8 further comprising an accounting module for recording and maintaining monetized value and redemptions thereof.

13. The mobile textile recycling redemption system of claim 8 further comprising a printer communicatively linked to said terminal.

14. A mobile textile recycling redemption system comprising:
one or more conveyor members;
a scale;
a printer;
a mobile storage unit;
a terminal comprising at least a processor, display, user interface and memory;
said terminal configured to accept at least weighed amounts of recyclables and determine a monetized value thereof; and
wherein said terminal is further configured to instruct said printer to print a voucher or coupon redeemable in amount of said monetized value of said recyclables, said voucher or coupon redeemable at a host business only.

15. The mobile textile recycling redemption system of claim 14 wherein said scale is communicatively linked to said terminal.
